(19) United States
(12) Patent Application Publication
(10) Pub. No.: US 2005/0202731 A1
(43) Pub. Date: Sep. 15, 2005

(54) Vehicle battery terminal connector

(76) Inventor: Jaime Brito, Brownsville, TX (US)

Correspondence Address: David G. Henry, 900 Washington Ave., P.O. Box 1470, Waco, TX, 76703-1470, US

(21) Appl. No.: 10/798,648

(22) Filed: Mar. 11, 2004

(51) Int. Cl. H01R 4/30

(52) U.S. Cl. 439/764

(57) ABSTRACT

An improved battery terminal or connector for vehicle batteries which does not require tools, either for removal or reinstallation of the terminal vis a vis a vehicle battery, or for removal or reinstallation of the terminal itself vis a vis vehicle electrical cables. The preferred embodiment includes wing nut connectors, both for a side-pole vehicle battery pole aperture, and for attachment of the terminal to the vehicle's electrical cable. Alternative embodiments include cam-type lever assemblies which, with the movement of respective levers, engages or releases the terminal vis a vis the vehicle's battery posts or electrical cables.

### BACKGROUND OF THE INVENTION

1. Field of the Invention

The present invention relates to electrical connectors, and in particular to connectors used to connect electrical cables to vehicle batteries.

2. Background Information

A deficiency presently exists with respect existing battery terminals or connectors, as used with conventional post-type vehicle batteries.

As is well known to anyone who has had to remove or replace a car or truck battery, conventional terminals are very difficult to use. Even if the connectors are in perfect shape, a wrench (or often two wrenches) are required to properly loosen or re-tighten the terminal for proper engagement with the battery posts.

Far too often, a wrench of the correct size is not available, and pliers, channel locks, or the like are used, with the inevitable damage to the bolt and nut heads. This, in turn, makes the next removal/installation process even more difficult, and risks other than a proper re-installation for lack of ability to properly tighten the terminal.

Even if a wrench of the proper size is available, removing and re-installing a battery terminal on a vehicle battery is simply inconvenient. Worse still is the replacement of the battery terminal itself, when the existing terminal becomes unserviceable. Replacing a terminal requires still another sized wrench or socket for removing and re-attaching the terminal to the vehicle's electrical cables.

It would well serve vehicle owners, or those who service vehicles for owners, to provide an improved design for a vehicle battery terminal—one which is more easily removed and replaced, preferably without requiring tools of any kind.

### SUMMARY OF THE INVENTION

In view of the foregoing, it is an object of the present invention to provide an improved vehicle battery terminal.

It is another object of the present invention to provide an improved vehicle battery terminal which is more easily removed or installed than conventional such terminals.

It is another object of the present invention to provide an improved vehicle battery terminal which is more easily removed or installed than conventional such terminals, and requires no tools for doing so.

In satisfaction of these and other related objectives, Applicant's present invention provides an improved battery terminal for use with vehicle type batteries with posts. The present terminal eliminates the need for tools to either install or remove the terminal vis a vis the vehicles battery posts, or to remove the terminal itself from the vehicle's electrical cables.

The preferred embodiment of the present invention includes two cam/lever assemblies which, upon actuation, reversibly enlarge or reduce the respective interior dimensions of the terminal's battery post-reception aperture or cable reception orifice for, respectively, engaging or releasing the battery post or electrical cable's terminal end situated therein.

### BRIEF DESCRIPTION OF THE DRAWINGS

FIG. 1 is a perspective view of one embodiment of the improved battery terminal of the present invention.

FIG. 2 is a perspective view of a second embodiment of the improved battery terminal of the present invention.

FIG. 3 is a perspective view of a third embodiment of the improved battery terminal of the present invention.

FIG. 4 is a perspective view of the preferred embodiment of the present invention.

### DETAILED DESCRIPTION OF THE PREFERRED EMBODIMENT

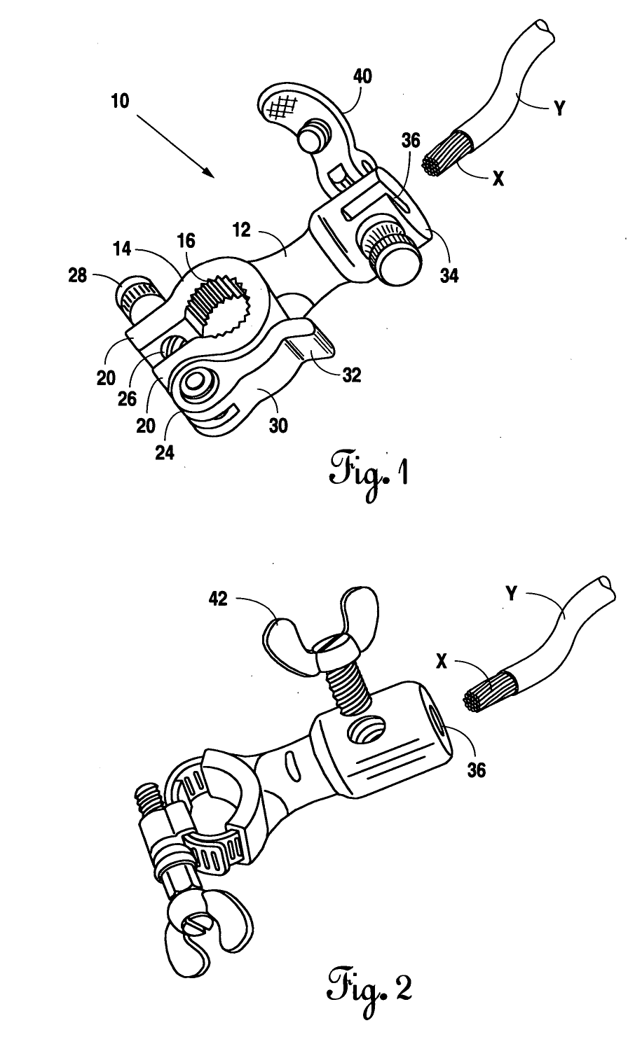

With reference to FIG. 1, the a first embodiment of the battery terminal of the present invention is identified generally by the reference number 10.

Battery terminal 10 includes a body member 12 of which several sub-components are integral parts, in the preferred embodiment.

Body member 12 includes a post-engagement means 14 which, in the preferred embodiment, constitutes a C-shaped structure which, in turn, defines a post-reception aperture 16. Post-reception aperture 16 is sized and shaped to telescopically receive a conventional vehicle battery post therein (not shown in the drawings). As is conventional for vehicle battery terminals, striations or ribs 18 are formed on the annular, interior faces of post-reception aperture 16, for positive “biting” of the terminal into the battery posts.

Extending from post engagement means 14 are two clamping tab members 20 two cooperatively aligned holes 22 formed therethrough.

Engaged with clamping tab members 20 is a post-securing cam assembly 24. Post-securing cam assembly 24 includes a rod member 26 which extends through holes 22 of clamping tab members 20, a stop 28 which secures the engagement of rod member 26 with clamping tab members 26 and a cam lever assembly 30, with an actuating lever 32. Cam lever assembly 30 and the adjacent, outer surface of post-engagement means 14 are respectively configured whereby, when actuating lever 32 is moved to its locking position (or first position), a compressive force is applied by cam lever assembly 30 whereby clamping tab members 20 are drawn closer together, thereby reducing post-reception aperture 16 in size. This, of course, effects a clamping or grasping action by post-engagement means 14 vis a vis a vehicle battery post (not shown in the drawings).

When actuating lever 32 is moved to its unlocked position (or second position), pressure is released, and clamping tab members 20 are allowed to return to their unstressed, more open relative position, whereby post-reception aperture 16 is enlarged (such as when a user wishes to disengage terminal 10 from his or her vehicle's battery post.

Another portion of body member 12 is the cable securing means 34—that portion which positively engages the terminal 10 with the terminal end X of a vehicle's electrical cable Y. Cable securing means 34 defines a cable reception orifice 36 which is sized to receive terminal end X of electrical cable Y telescopically therein.

In this embodiment of the present battery terminal 10, a cable clamping cam assembly 40 is provides, which, in like structure and function to post-securing cam assembly 30, compresses cable securing means 34 (as allowed by the presence of a longitudinal slot 38) for clamping onto terminal end X.

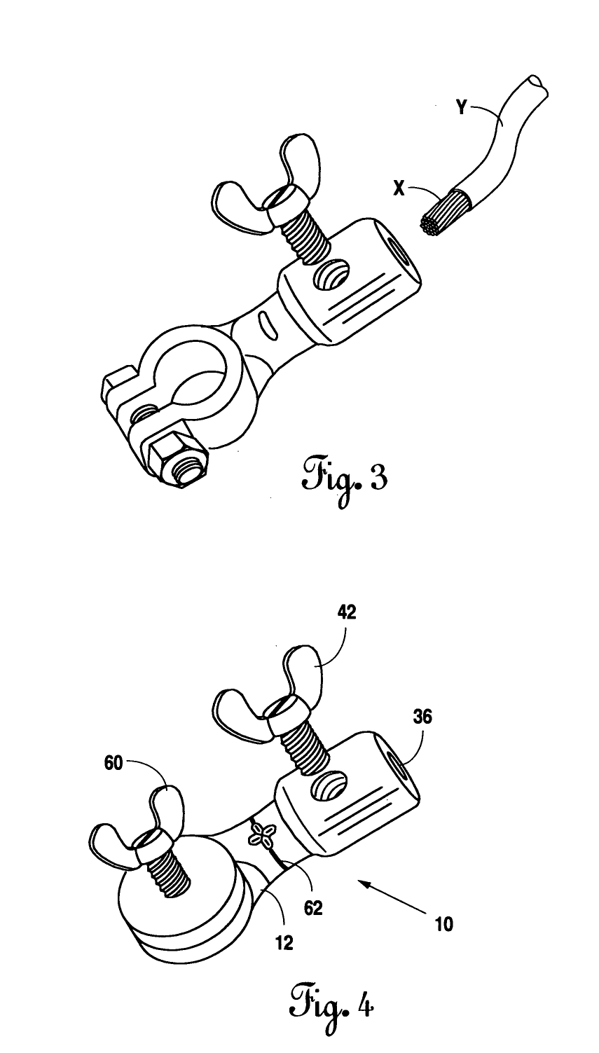

A second embodiment (FIG. 2) involves a wing bolt 42, the end of which extends into cable reception orifice 36 for, upon advancing wing bolt 42 into orifice 36, impinging on terminal end X, and, conversely, when moving wing bolt 42 in the opposite direction, disengaging from terminal end X for allowing the removing thereof from the cable reception orifice 36 this embodiment of the present invention (see FIG. 3) also replaces post-securing cam assembly 30 with a wing bolt and nut assembly 50 as shown. This embodiment represents an improvement over presently available, conventional terminals designs.

As is exemplified by the embodiment shown in FIG. 3, the use of the cable securing scheme involving the wing bolt 42, even with a more conventional embodiment of the post-securing structure Z, provides a substantial improvement with respect to removing and attaching the terminal itself to an electrical cable Y.

Referring to FIG. 4, the preferred embodiment of the present invention provides for the use with a “side-pole” vehicle battery. In this embodiment, a wing bolt 60 is sized and configured for engaging the threaded receptacle of a “side-pole” battery (not shown in the drawings). In this embodiment wing bolt 60 is carried by the body 12 of the terminal 10 such that it threads into the threaded orifice which constitutes each pole of the side-pole battery, Wing bolt 42 is used to secure the electrical cable Y. Use of both wing bolts for these purposes completely eliminates the need for tools in using the terminal. A pivot or swivel joint 62 (or suitable alternative structure) may be provided for body 12 to allow for rotating the two ends of body 12 such that the wing bolts 42 and 62 are oriented either the same, or differently, depending on circumstances of installation space, etc.

Although the invention has been described with reference to specific embodiments, this description is not meant to be construed in a limited sense. Various modifications of the disclosed embodiments, as well as alternative embodiments of the inventions will become apparent to persons skilled in the art upon reference to the description of the invention. It is, therefore, contemplated that the appended claims will cover such modifications that fall within the scope of the invention.

1. A vehicle battery terminal comprising:
battery pole engagement means configure for reversible engagement with a pole of a vehicle battery; and
cable engagement means for connecting said battery terminal to a terminal length of an electrical cable, said cable engagement means includes a cable orifice which is sized and shaped for receiving therein said terminal length of electrical cable, and further comprises a wing bolt having one or more lobes providing for hand actuation, threadinlgy engaged with said cable engagement means whereby a terminal end of said wing bolt protrudes into said cable orifice for reversibly impinging on said terminal length of said electrical cable.

2. The vehicle batter terminal of claim 1 wherein said battery pole engagement means is a second wing bolt supported and positioned by said terminal for reversibly, threadingly engaging with a threaded receptacle pole of a side pole battery.

3. A vehicle battery terminal comprising:
post-engagement means configured for reversible engagement with a vehicle battery post, said post-engagement means defining a post-reception aperture and having clamping tab members configured whereby, when said clamping tab members are drawn closer together, said post-reception aperture is reduced in size, and when said clamping tab members are spaced farther apart, said post-reception aperture is enlarged;
a post-securing cam assembly operatively engaged with said clamping tab members of said post-engagement means, said post-securing cam assembly having actuator means moveable between first and second positions, said post-securing cam assembly when in said first position effecting a reduction in size of said post-reception aperture, and when in said second position effecting an enlargement of said post-reception aperture as compared with the size of said post-reception aperture when said post-securing cam assembly is in said first position; and
cable engagement means having one or more lobes providing for hand actuation of said cable engagement means for connecting said battery terminal to a terminal length of an electrical cable.

4. The battery terminal of claim 3 wherein said cable engagement means includes a cable orifice which is sized and shaped for receiving therein said terminal length of electrical cable, and further comprises cable securing means which, upon actuation, reduces said cable orifice in size for graspingly engaging said terminal length of said electrical cable.

5. The battery terminal of claim 3 wherein said cable engagement means includes a cable orifice which is sized and shaped for receiving therein a terminal length of electrical cable, and further comprises a cable securing bolt member which is threadingly engaged with said battery terminal whereby a terminal end of said cable securing bolt member, upon rotation thereof, reversibly impinges on said terminal length of said electrical cable when in said cable orifice.

6. The battery terminal of claim 4 wherein said cable securing means is a cam assembly which, upon actuation, reduces said cable orifice in size for graspingly engaging said terminal length of said electrical cable.
